(19) United States
(12) Patent Application Publication
(10) Pub. No.: US 2005/0008440 A1
(43) Pub. Date: Jan. 13, 2005

(54) Discharging filter rods from a conveying conduit

(75) Inventor: Michael Haul, Kroppelshagen (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/885,071

(22) Filed: Jul. 7, 2004

(30) Foreign Application Priority Data
Jul. 9, 2003 (EP) 03 015 709.3

(51) Int. Cl. B65G 51/00

(52) U.S. Cl. 406/83

(57) ABSTRACT

Method and device for longitudinally axial transfer of rod-shaped articles from a transmitting station to a receiving station via a connecting conduit. The method includes separating the articles in the connecting conduit, and discharging the articles from the connecting conduit by a discharge device. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of European Patent Application No. 03 015 709.3, filed on Jul. 9, 2003, the disclosure of which is expressly incorporated by reference herein in its entirety.

### BACKGROUND OF THE INVENTION

1. Field of the Invention

The invention relates to a method and a conveying device for the longitudinally axial transfer of rod-shaped articles of the tobacco processing industry, in particular filter rods, from a transmitting station to a receiving station via a connecting conduit.

For the purpose of the invention, “rod-shaped articles of the tobacco processing industry” primarily refers to filter rods that are transferred for the purpose of supplementing supplies in magazines of processing machines by compressed air via transport conduits bridging relatively large distances between a transmitting device assigned, e.g., to a filter producing machine and a receiving device assigned, e.g., to a filter tipping machine.

2. Discussion of Background Information

Pneumatic conveying devices in which rod-shaped articles are conveyed axially one behind the other through a conduit from a distributor unit to a receiver unit by compressed air are known in the tobacco industry. Devices of this type thus form a tubular conduit system extending over relatively large distances with straight and curved conduit sections through which in normal operation filter rods of different length are transported by compressed air with reciprocal spacing remaining approximately the same. Maintaining the conduit pressure as a function of the given parameters is essential in order to guarantee operation free of disruption.

A device for conveying filter rods to a filter magazine or a corresponding method for conveying filter rods to a filter magazine is known through the applicant's so-called filter rod feed system FILTROMAT 3 FE. Such a filter rod feed system or such a filter rod receiver receives filter rods conveyed in a longitudinally axial manner, which filter rods are first braked in order to be then accelerated in a longitudinally axial manner and subsequently fed to the filter magazine in a transverse axial manner. Various module variants are hereby known. For example, there are individual receivers, double receivers and triple receivers. The speed of the filter rod receiver is regulated depending on the demand for the filter rods.

A conveyor device for transporting filter rods between a transmitting station and a receiving station via a pneumatic conveying conduit is described in DE-A-197 40 070.

According to DE-A-100 02 753 a connecting conduit of a pneumatic conveying device has a deflectable conduit section so that, in the event of an article jam in the receiving station, the articles are discharged in a limited number before entering the receiving station. In this manner the disturbance caused by the article jam in the receiving station is eliminated quickly and unhindered through an intervention from outside in the receiving station.

Furthermore, DE-A-43 38 369 discloses a conveying conduit for rod-shaped objects whereby a gate member is provided in a section of the conveying duct, which gate opens as a function of signals that indicate a jam of filter rods in a receiver unit connected to the conveying duct. When the gate member is opened, the filter rods remaining in the conveying duct are directed to a bin for rejected articles. A filter rod jam that leads to damage of the filter rods before the receiver unit is thus avoided.

### SUMMARY OF THE INVENTION

Accordingly, the present invention improves the feed of filter rods to a receiving station. In this manner, it should be possible to influence the stream of filter rods in a targeted manner and, if possible, to detect predetermined, in particular defective, filter rods.

The method is directed to the longitudinally axial transfer of rod-shaped articles of the tobacco processing industry, in particular filter rods, from a transmitting station to a receiving station via a connecting conduit in that the articles in the connecting conduit are discharged from the connecting conduit separately and by a discharge device. Through the separation it is possible for the articles conveyed one behind the other to be drawn apart so that an adequate gap is created between the articles in order to subsequently remove certain articles from the connecting conduit. Consequently not all the filter rods reach a receiving station. The mass flow of filter rods can thus be influenced in a targeted manner.

A discharge of articles from the connecting conduit is carried out in particular when the articles are tested by a monitoring device and discharged depending on the test result. Only unflawed filter rods thus reach the receiving station. Damaged filter rods or filter rods that are too large or too small are removed from the further production process. A monitoring device for filter rods is described in European patent application no. 020 20 291.7, the disclosure of which is expressly incorporated by reference herein in its entirety.

Furthermore, it is advantageous for the articles to be tested after the separation so that several physical values of the filter rods are determined at the same time with the above-mentioned monitoring device.

In a further development of the invention the articles are discharged by being acted on, in particularly laterally, by air, preferably compressed air. During their longitudinally axial conveyance, filter rods are thus removed from the connecting conduit, e.g., by a blast of compressed air. This represents a simple measure.

In an alternative embodiment of the invention, the articles are discharged from the connecting conduit by a transverse axial transport. To this end a discharge device is provided which removes, e.g., a damaged filter rod from the connecting conduit and at the same time as the discharge of the defective filter rod, restores or provides the connecting conduit between the separating device and the receiving station.

Furthermore, the object is attained through a conveying device for the longitudinally axial transfer of rod-shaped articles of the tobacco processing industry, in particular filter rods, from a transmitting station to a receiving station via a connecting conduit that is further developed in that at least one separating device for the articles and at least one discharge device is provided on the connecting conduit in the conveyor direction of the articles.

Expediently a monitoring device for the articles is provided, in particular between the separating device and the discharge device.

Preferably the separating device is provided at least with a braking device, in particular a pair of braking rollers, and/or with an accelerating device, in particular a pair of accelerating rollers.

A simple embodiment of the invention is given when the discharge device features at least two tube sections, whereby one tube section is arranged coaxially to the conveying conduit in the working position and the at least second tube section in the initial position.

Furthermore, it is favorable if a tube section can be brought from the initial position into the working position, and at the same time the tube section in the working position can be brought into the initial position, in particular by rotating or displacing the discharge device.

Advantageously at least one drive device is provided for the discharge device, so that the discharge device is moved quickly.

In an alternative embodiment of the invention the discharge device is embodied by an opening, in particular a lateral opening, of the connecting conduit and at least one air blast nozzle.

Furthermore the opening of the connecting conduit can be closed by a cover.

In a preferred design it is provided that the cover can be brought into the open position for the discharge of a filter rod, in particular by a valve.

In order to feed only individual filter rods to the discharge device, advantageously a light barrier is provided before the discharge device.

Advantageously a collecting receptacle is provided for the discharged articles at the conveyor device.

The advantage obtained with the invention is that an adequate spacing between two filter rods conveyed one behind the other is created by an independent separating device so that the filter rods are subsequently tested by a monitoring or measuring device for certain physical properties, such as, e.g., diameter and/or length. On the basis of these test results filter rods of poor or defective quality are discharged before they enter the receiver.

The present invention is directed to a method for longitudinally axial transfer of rod-shaped articles from a transmitting station to a receiving station via a connecting conduit. The method includes separating the articles in the connecting conduit, and discharging the articles from the connecting conduit by a discharge device.

In accordance with a feature of the invention, the rod-shaped articles may be articles of the tobacco processing industry, and the articles of the tobacco process industry can be filter rods.

According to another feature of the present invention, the method can further include testing the articles with a monitoring device, and discharging the articles depending upon a result of the test.

In accordance with still another feature, the testing may occur after separating the articles.

Further, the discharging can include directing air at the article, and the air may be supplied by a compressed air source. Still further, the air can be directed in a direction crosswise to a longitudinal axis of the rod-shaped article, such that the article is discharged laterally to the transport direction.

According to a further feature of the instant invention, the discharging may include a transverse axial transport of the article.

Moreover, the discharging device can include at least two movable cylinders structured to pass the article, and the process may further include testing the articles after separating, and shifting the position of the at least two movable cylinders in response to a result of the testing. The at least two movable cylinders can move in response to a result that the rod-shaped article is irregular in at least one physical parameter. Further, the discharging device can include a rotatable cylinder having a plurality of axial bores arranged around the periphery of the cylinder that are dimensioned to pass the articles.

The instant invention is directed to a conveying device for longitudinally axial transfer of rod-shaped articles from a transmitting station to a receiving station via a connecting conduit. The device includes at least one separating device structured and arranged to separate the articles transmitted from the transmitting station, and at least one discharge device coupled to the connecting conduit to discharge the separated articles.

According to the invention, the rod-shaped articles can be articles of the tobacco processing industry, and the articles of tobacco processing industry comprise filter rods.

In accordance with another feature of the present invention, a monitoring device may be structured to monitor the articles. Further, the monitoring device can be positioned between the separating device and the discharge device, and the separating device may include at least one of: at least one braking device and an accelerating device. The at least one braking device can have a pair of braking rollers and the accelerating device can have a pair of accelerating rollers.

In accordance with still another feature of the invention, the discharge device can include at least two tube sections. One of the at least two tube sections, in a working position, may be coaxially arranged with the conveying conduit and another of the at least two tube sections may be arranged in an idle position. The another tube section is movable from the initial position into the working position, while the one tube section is concurrently movable from the working position into the idle position. The one and another tube sections can be movable by rotating the discharge device.

According to another feature of the invention, the discharge device may include at least one drive element.

Moreover, the discharge device can include an opening in the connecting conduit and at least one air blast nozzle. The opening may include an opening arranged laterally to a transfer direction. Further, the opening can be closable with a cover, in which the cover can be selectively openable in order to discharge the article. Still further, the cover may be selectively openable by a valve.

In accordance with a further feature of the invention, a light barrier can be located before the discharge device.

According to another feature of the instant invention, the discharge device can be structured to move the article in a transverse axial direction.

In accordance with the invention, a measuring device can be structured and arranged to measure physical parameters of the article, and the discharge device may have at least two movable cylinders structured to pass the article. The at least two movable cylinders are positionable in response to the measured parameters of the article. The at least two movable cylinders can move in response to a result that the article is irregular in at least one of the measured physical parameters. Further, the discharging device may include a rotatable cylinder having a plurality of axial bores arranged around the periphery of the cylinder that are dimensioned to pass the articles, and the rotatable cylinder can rotate in response to a result that the article is irregular in at least one of the measured physical parameters.

The invention is directed to a method for transferring articles from a first location to a second location, that includes transmitting the articles from the first location, separating, between the first and second locations, the articles from each other, passing selected ones of the articles to the second location, and discharging selected others of the articles to a discharge location separate from the second location.

In accordance with still yet another feature of the present invention, the separated articles can be tested for physical characteristics, and when an irregularity is discovered in a specific article, the specific article is selected to be discharged. Further, the articles can include rod-shaped elements axially transported from the first location toward the second location, and, the other articles selected for discharge can be moved transversely to the axial transport direction.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 diagrammatically illustrates view of a filter rod receiver with a receiving station;

FIG. 2 diagrammatically illustrates a discharge device according to the invention in two working positions;

FIG. 3 diagrammatically illustrates a cross-sectional view of a further discharge device according to the invention;

FIGS. 4a and 4b illustrate a further discharge device according to the invention in cross section in two working positions; and

FIGS. 5a and 5b illustrate two views of a pneumatic conveying device with a curved connecting conduit.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

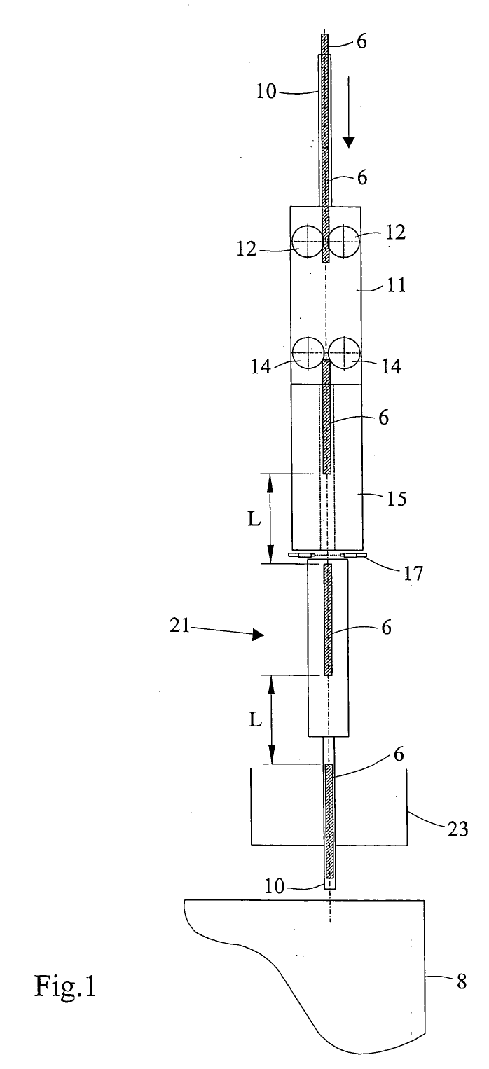

FIG. 1 shows a filter rod receiver for conveying filter rods 6 into a filter magazine 8. The filter magazine 8 has the function of a receiver for the filter rods 6. The filter rods 6 fed into the filter magazine 8, after being cut, e.g., into filter rods of double unit length, are used to be joined with pairs of cut tobacco rods in order to produce filter cigarettes.

Alternatively, the filter rods 6 fed into the filter magazine 8 can also be used cut into corresponding filter segments and with an arrangement of filter segments to be fed for the production of multi-segment filters.

The filter rods 6 with an n-fold unit length are fed via an inlet pipe 10 from a filter-making machine to the filter magazine 8 by a filter rod transmitter. Hereby the filter rods 6 are first fed to an accelerating unit 11 in which the arriving filter rods 6 are first braked by braking rollers 12 and subsequently accelerated by accelerating rollers 14.

Following the accelerating unit 11, the filter rods 6 are transported in an accelerated manner to a measuring device 15 by the accelerating rollers 14. Through the measuring device 15 it is determined, e.g., whether a filter rod meets the predetermined quality criteria. These quality criteria can be, e.g., the length and/or the diameter of the respective filter rod.

The filter rods 6 are separated through the acceleration of the filter rods 6 in the accelerating unit 11. An adequate spacing L is thus created between the filter rods so that the filter rods 6 are tested individually by the measuring device 15. A measuring device of this type is described, e.g., in European application no. 02020291.7. In an alternative embodiment, the accelerating unit 11 has only one pair of rollers through which the filter rods 6 are accelerated.

After passing through the measuring device 15, a light barrier 17 is arranged at the outlet of the measuring device 15 in the transition to a discharge 21. By the light barrier 17 it is ascertained whether the filter rod tested in the measuring device 15 is completely inserted into the discharge 21.

Through the measuring device 15 it is determined that the filter rod 6 located in the discharge 21 is defective. With a defective filter rod the discharge 21 is controlled so that this filter rod 6 does not enter the filter magazine 8 but a rejection box 23. The reversal of the discharge is hereby to be carried out within the spacing L created between two filter rods conveyed one behind the other. In particular the operating parameters are to be selected so that a second following filter rod is not fed into the discharge 21.

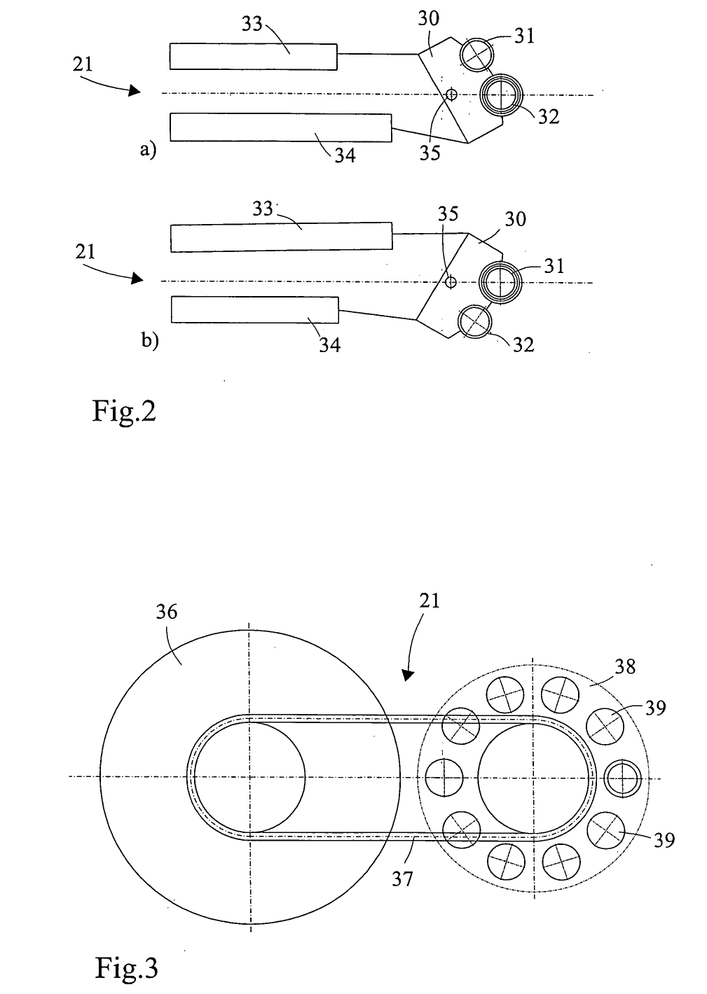

FIG. 2 shows in diagrammatic form a first embodiment of a discharge 21 with two positions (case a, case b) in cross section. The discharge 21 has a support 30 that can be pivoted around a swivel axis 35, on which support two tubes 31, 32 arranged in a parallel manner are arranged. The support 30 is driven in a pivotable manner by two linear motors 33, 34 that are connected to the support 30.

In a first position (case a), the tube 32 is arranged coaxially to the inlet pipe 10 (cf. FIG. 1) in the working position. In this position of the tube 32, the filter rods are conveyed through this tube. If a defective filter rod is located in the tube section 32, the motors 33, 34 are activated so that the tube 32 together with the defective filter rod is swiveled out of this working position and the filter rod is transported to the rejection box 23. Through the swiveling of the support 30, the pipe section 31 is arranged in the working position, i.e. coaxially to the inlet pipe 10 (case B). The tube 31 is kept in this working position until a defective filter rod is conveyed through the tube 30, so that the support 30 is swiveled back (case a).

According to an alternative embodiment (not shown here), the tubes 31, 32 are arranged on a linearly displaceable body and are driven analogously to the principle shown above. This means that filter rods are transported through a tube section until a defective filter rod arrives at the tube section and is discharged through the displacing movement. At the same time another tube section is arranged coaxially to the inlet pipe.

Another embodiment of a discharge 21 is shown diagrammatically in cross section in FIG. 3. In this embodiment of the discharge 21, several tubes 39 are arranged on a drum body 38 in a star-shaped manner and collinearly to one another. The drum body 38 is pivoted and is driven by a motor 36 via a belt 37. In this discharge 21 respectively only one tube is arranged coaxially to the inlet pipe 10. If a damaged filter rod is located in this tube 39, the motor 36 is activated and conveys the filter rod out of the inlet pipe to the filter magazine with a rotation of the drum body 38. Through the rotation an empty tube 39 is arranged coaxially to the inlet pipe 10 at the same time.

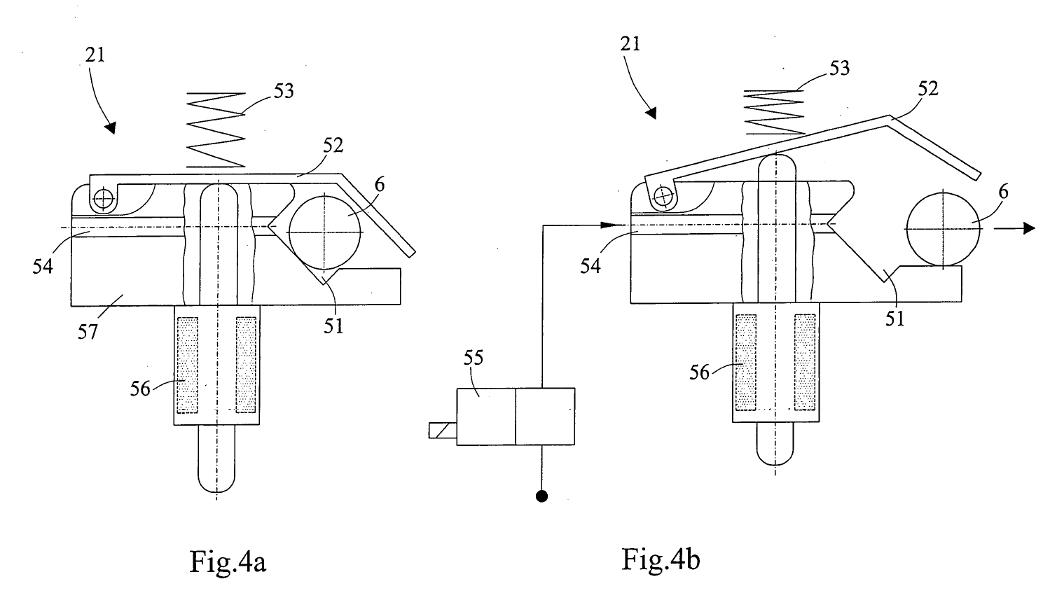

FIGS. 4a, 4b show a discharge 21 according to a further embodiment in cross section. The discharge 21 has an open channel 51 in which the filter rods 6 are conveyed. The channel 51 is embodied in an open manner and is closed by a cover 52 for the transport of the filter rods. The cover 52 can be swiveled and is pushed down by a spring 53 arranged above. The cover 52 is arranged on a discharge body 57 in a swiveling manner. Moreover the discharge body 57 has an air blast channel 54 through which an air blast is acted on with compressed air during the opening of the transport channel 51 by swiveling the cover 52.

If a defective filter rod 6 is transported in the channel 51 in a longitudinally axial manner, the cover 52 is swiveled out of its idle position by a sliding magnet 56. The sliding magnet 56 hereby presses from below against the cover 52 and against the spring tension of the pressure spring 53.

When the cover 52 is swiveled, a pilot valve 55 is activated at the same time so that the filter rod 6 is acted on with compressed air through the air blast channel 54 and this filter rod 6 is blown out of the opened channel 51 (FIG. 4b).

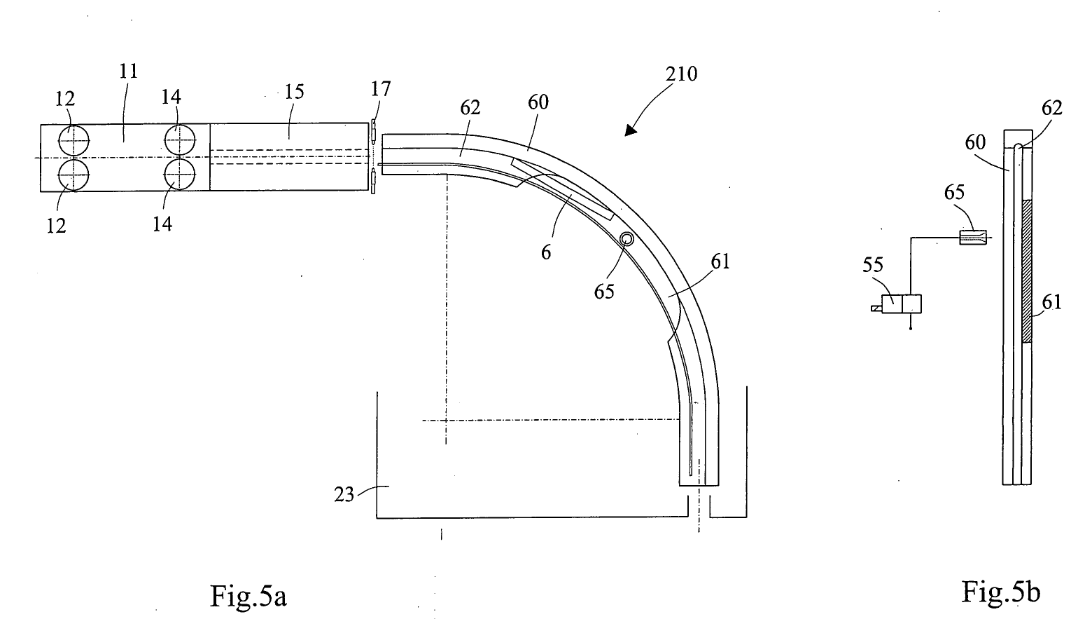

FIGS. 5a, 5b shows another discharge 210 according to another preferred embodiment in two views in diagrammatic form. FIG. 5a shows a side view of the discharge 210. FIG. 5b shows a plan view from below.

In the discharge 210, arriving filter rods 6 are separated by the accelerating unit 11 and subsequently transported through the measuring unit 15. After passing through the light barrier 17, the filter rods 6 run through a curved section 60 with a guide groove 62 and are deflected downwards in a perpendicular manner. The curved section 60 has a recess 61 at the side. An air blast nozzle 65 is arranged on the curved section 60 in the area of the recess 61 on the opposite side wall of the curved section 60 open below. When a defective filter rod is detected, the air blast nozzle 65 is acted on with compressed air via a pilot valve 55 so that the filter rod 6 entering the curved section 60 is acted on laterally with compressed air and flies away laterally through the recess 61 and reaches the rejection box. The lateral arrangement of the air blast nozzle 65 with reference to the recess 61 is shown diagrammatically in FIG. 5b.

Through the invention, poor-quality and defective filter rods are removed from the further production process before they reach a receiver. Disturbances through broken filters in the receiver are thus avoided.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

6 Filter rod
8 Filter magazine
10 Inlet pipe
11 Accelerating unit
12 Braking rollers
14 Accelerating rollers
15 Measuring device
17 Light barrier
21 Discharge
23 Rejection box
30 Support
31 Tube
32 Tube
33 Motor
34 Motor
35 Swivel axis
36 Motor
37 Belt
38 Drum body
39 Tube
51 Channel
52 Cover
53 Pressure spring
54 Air blast channel
55 Pilot valve
56 Sliding magnet
57 Discharge body
60 Curved section
61 Recess
62 Guide groove
65 Air blast nozzle
210 Discharge
L Spacing

1. A method for longitudinally axial transfer of rod-shaped articles from a transmitting station to a receiving station via a connecting conduit, comprising:
separating the articles in the connecting conduit; and
discharging the articles from the connecting conduit by a discharge device.

2. The method in accordance with claim 1, wherein the rod-shaped articles are articles of the tobacco processing industry.

3. The method in accordance with claim 2, wherein the articles of the tobacco process industry are filter rods.

4. The method in accordance with claim 1, further comprising:
testing the articles with a monitoring device; and
discharging the articles depending upon a result of the test.

5. The method in accordance with claim 1, wherein the testing occurs after separating the articles.

6. The method in accordance with claim 1, wherein the discharging comprises directing air at the article.

7. The method in accordance with claim 6, wherein the air is supplied by a compressed air source.

8. The method in accordance with claim 6, wherein the air is directed in a direction crosswise to a longitudinal axis of the rod-shaped article, such that the article is discharged laterally to the transport direction.

9. The method in accordance with claim 1, wherein the discharging comprises a transverse axial transport of the article.

10. The method in accordance with claim 1, wherein the discharging device comprises at least two movable cylinders structured to pass the article, and the process further comprises:
testing the articles after separating; and
shifting the position of the at least two movable cylinders in response to a result of the testing.

11. The method in accordance with claim 10, wherein the at least two movable cylinders move in response to a result that the rod-shaped article is irregular in at least one physical parameter.

12. The method in accordance with claim 10, wherein the discharging device comprises a rotatable cylinder having a plurality of axial bores arranged around the periphery of the cylinder that are dimensioned to pass the articles.

13. A conveying device for longitudinally axial transfer of rod-shaped articles from a transmitting station to a receiving station via a connecting conduit, the device comprising:
at least one separating device structured and arranged to separate the articles transmitted from the transmitting station; and
at least one discharge device coupled to the connecting conduit to discharge the separated articles.

14. The conveying device in accordance with claim 13, wherein the rod-shaped articles are articles of the tobacco processing industry.

15. The conveying device in accordance with claim 14, wherein the articles of tobacco processing industry comprise filter rods.

16. The conveying device in accordance with claim 13, further comprising a monitoring device structured to monitor the articles.

17. The conveying device in accordance with claim 16, wherein said monitoring device is positioned between said separating device and said discharge device.

18. The conveying device in accordance with claim 17, wherein said separating device comprises at least one of: at least one braking device and an accelerating device.

19. The conveying device in accordance with claim 18, wherein said at least one braking device comprises a pair of braking rollers and said accelerating device comprises a pair of accelerating rollers.

20. The conveying device in accordance with claim 13, wherein the discharge device comprises at least two tube sections, wherein one of said at least two tube sections, in a working position, is coaxially arranged with the conveying conduit and another of the at least two tube sections is arranged in an idle position.

21. The conveying device in accordance with claim 20, wherein said another tube section is movable from the initial position into the working position, while said one tube section is concurrently movable from the working position into the idle position.

22. The conveying device in accordance with claim 21, wherein said one and another tube sections are movable by rotating said discharge device.

23. The conveying device in accordance with claim 13, wherein said discharge device comprises at least one drive element.

24. The conveying device in accordance with claim 13, wherein said discharge device comprises an opening in the connecting conduit and at least one air blast nozzle.

25. The conveying device in accordance with claim 24, wherein said opening comprises an opening arranged laterally to a transfer direction.

26. The conveying device in accordance with claim 24, wherein said opening is closable with a cover.

27. The conveying device in accordance with claim 26, wherein said cover is selectively openable in order to discharge the article.

28. The conveying device in accordance with claim 27, wherein said cover is selectively openable by a valve.

29. The conveying device in accordance with claim 13, further comprising a light barrier located before said discharge device.

30. The conveying device in accordance with claim 13, wherein said discharge device is structured to move the article in a transverse axial direction.

31. The conveying device in accordance with claim 13, further comprising a measuring device structured and arranged to measure physical parameters of the article, wherein the discharge device comprises at least two movable cylinders structured to pass the article, and the at least two movable cylinders are positionable in response to the measured parameters of the article.

32. The conveying device in accordance with claim 31, wherein the at least two movable cylinders move in response to a result that the article is irregular in at least one of the measured physical parameters.

33. The conveying device in accordance with claim 31, wherein the discharging device comprises a rotatable cylinder having a plurality of axial bores arranged around the periphery of the cylinder that are dimensioned to pass the articles, and the rotatable cylinder rotates in response to a result that the article is irregular in at least one of the measured physical parameters.

34. A method for transferring articles from a first location to a second location, comprising:
transmitting the articles from the first location;
separating, between the first and second locations, the articles from each other;
passing selected ones of the articles to the second location; and
discharging selected others of the articles to a discharge location separate from the second location.

35. The method in accordance with claim 34, wherein the separated articles are tested for physical characteristics, and when an irregularity is discovered in a specific article, the specific article is selected to be discharged.

36. The method in accordance with claim 35, wherein the articles comprise rod-shaped elements axially transported from the first location toward the second location, and, the other articles selected for discharge are moved transversely to the axial transport direction.
